(19) United States
(12) Patent Application Publication
(10) Pub. No.: US 2025/0065798 A1
(43) Pub. Date: Feb. 27, 2025

(54) TIE DOWN ANCHOR ASSEMBLY FOR STAKE BED TRAILER POCKETS

(71) Applicant: Erik Lutz Enterprise LLC., Wauconda, IL (US)

(72) Inventor: Erik Daniel Lutz, Wauconda, IL (US)

(21) Appl. No.: 18/798,807

(22) Filed: Aug. 8, 2024

Related U.S. Application Data
(60) Provisional application No. 63/578,077, filed on Aug. 22, 2023.

(51) Int. Cl. B60P 7/08

(52) U.S. Cl. CPC B60P 7/0807

(57) ABSTRACT

A tie down anchor assembly for a stake bed trailer pocket includes a tie down anchor body that includes a load receiving opening and first and second body grooves. The assembly further includes locating flanges that are attached to the tie down anchor body and are configured to be positioned within the stake pocket, and a retainer removably mounted to the tie down anchor body and positioned over the first and second body grooves. The first and second body grooves are configured to receive respective opposite first and second side walls of the stake pocket, and the retainer is configured to be positioned over the opposite first and second side walls of the stake pocket to secure the tie down anchor body to the stake pocket.

### FIELD OF THE INVENTION

This application relates to a tie down anchor assembly for stake bed trailer pockets.

### BACKGROUND OF THE INVENTION

Trucks or trailer or other vehicles are often used to haul a variety of loads at their rear end. To accomplish this task, they may include stake bed trailer pockets. Stake bed trailer pockets are defined by a rigid u-shaped metal bar that is mounted to or part of the rear edge of a truck bed or rear end of another type of vehicle. The trailer pocket extends rearwardly from the rear end of the vehicle. The stake bed trailer pockets can receive or can be attached to ratchet straps, rope, load securing chains, bungee cords, etc. It is desirable have the trucks, trailers, or other vehicles haul large loads.

### SUMMARY OF THE INVENTION

In one aspect of the present invention, a tie down anchor assembly for a stake bed trailer pocket is provided. The tie down anchor assembly includes a tie down anchor body. The tie down anchor body includes a load receiving opening and first and second body grooves. The tie down anchor assembly further includes locating flanges and a retainer. The locating flanges are attached to the tie down anchor body and are configured to be positioned within the stake pocket. The retainer is removably mounted to the tie down anchor body and is positioned over the first and second body grooves. The first and second body grooves are configured to receive respective opposite first and second side walls of the stake pocket, and the retainer is configured to be positioned over the opposite first and second side walls of the stake pocket to secure the tie down anchor body to the stake pocket.

In another aspect of the present invention, an apparatus is provided. The apparatus includes a stake pocket. The stake pocket includes opposite first and second side walls that are interconnected by an interconnecting wall. The stake pocket is configured to be mounted to a vehicle. The apparatus further includes a tie down anchor assembly. The tie down anchor body is secured to the stake pocket. The tie down anchor assembly includes a tie down anchor body. The tie down anchor body includes a load receiving opening and first and second body grooves. The tie down anchor assembly further includes locating flanges and a retainer. The locating flanges are attached to the tie down anchor body and are positioned within the stake pocket. The retainer is removably mounted to the tie down anchor body and is positioned over the first and second body grooves. The first body groove receives the first side wall, and the second body groove receives the second side wall. The retainer is configured to be positioned over the opposite first and second side walls of the stake pocket to secure the tie down anchor body to the stake pocket.

Other aspects of the disclosed invention will become apparent from the following detailed description, the accompanying drawings and the appended claims.

### BRIEF DESCRIPTION OF THE DRAWINGS

FIG. 1 is a front, right, and bottom perspective view of the tie down anchor assembly according to an embodiment of the present invention;

FIG. 2 is a right side view of the tie down anchor assembly FIG. 1;

FIG. 3 is a front view of the tie down anchor assembly FIG. 1;

FIG. 4 is a rear view of the tie down anchor assembly FIG. 1;

FIG. 5 is a front view of the tie down anchor body of the tie down anchor assembly of FIG. 1;

FIG. 6 is a left side view of the tie down anchor body of the tie down anchor assembly of FIG. 1;

FIG. 7 is a front view of the retainer of the tie down anchor assembly of FIG. 1;

FIG. 8 is a side view of the retainer of the tie down anchor assembly of FIG. 1;

FIG. 9 is a front view of a locating flange of the tie down anchor assembly of FIG. 1;

FIG. 10 is a right side view of a locating flange of the tie down anchor assembly of FIG. 1;

FIG. 11 is a front view of a fastener of the tie down anchor assembly of FIG. 1;

FIG. 12 is a right side view of a fastener of the tie down anchor assembly of FIG. 1;

FIG. 13 is a front, right, and top perspective view of the tie down anchor assembly of FIG. 1;

FIG. 14 is a rear, right, and top perspective view of the tie down anchor assembly of FIG. 1;

FIG. 15 is a top, right, and front perspective view of the tie down anchor assembly of FIG. 1 mounted to a stake bed trailer pocket on a vehicle;

FIG. 16 is a top, left and front perspective view of portion of a stake bed trailer pocket on a vehicle;

FIG. 17 is a top and front perspective view of the tie down anchor assembly of FIG. 1 mounted to a stake bed trailer pocket on a vehicle;

FIG. 18 is a front view of the tie down anchor assembly of FIG. 1 mounted to the stake bed trailer pocket on the vehicle with portions of the bed trailer pocket broken away at the side wall for illustrative purposes;

FIG. 19 is a perspective view of an alternative fastener in the form of a clevis pin and cotter pin to removably fasten the retainer to the tie down anchor body; and

FIG. 20 is a front, right, and top perspective view of the tie down anchor assembly of another embodiment of the present invention.

### DETAILED DESCRIPTION OF THE INVENTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

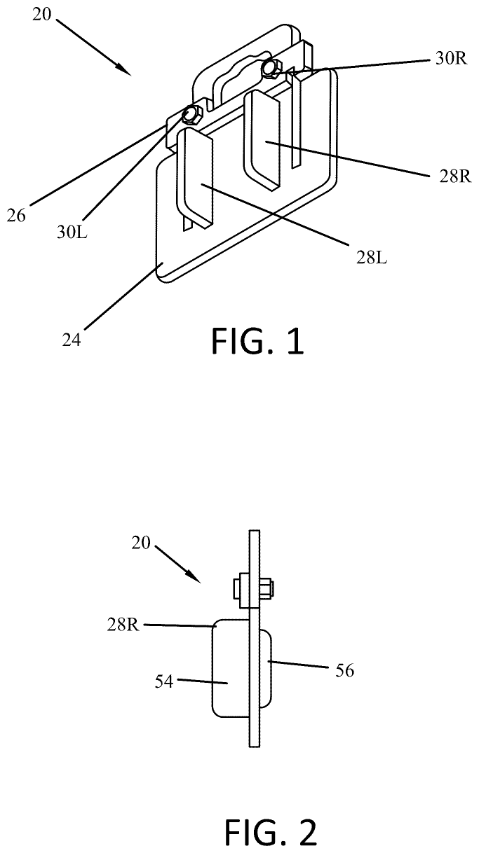

Throughout the present description, the terms “upper”, “lower”, “top”, “bottom”, “left”, “right”, “front”, “forward”, “rear”, and “rearward” shall define directions or orientations with respect to the tie down anchor assembly as illustrated in FIG. 1. It will be understood that the spatially relative terms “upper”, “lower”, “top”, “bottom”, “left”, “right”, “front”, “forward”, “rear”, and “rearward” are intended to encompass different orientations of the tie down anchor assembly in use or operation in addition to the orientation depicted in the figures. For example, if the tie down anchor assembly in the figures is turned over, elements described as “upper” elements or features would then be “lower” elements or features.

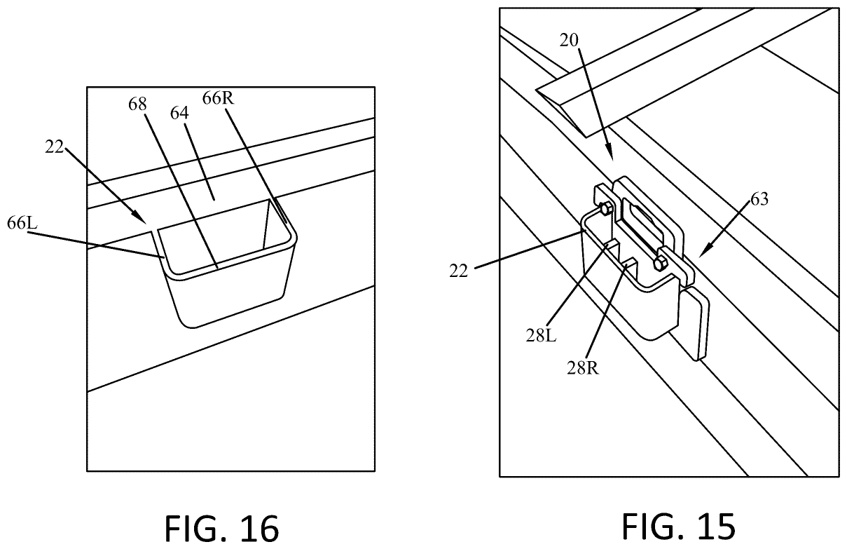

FIGS. 1 to 4 show a tie down anchor assembly 20. Referring to FIG. 1, the tie down anchor assembly 20 for a stake bed trailer pocket 22 (FIG. 16) is shown. The tie down anchor assembly 20 comprises a tie down anchor body 24, a retainer 26, a pair of left and right locating flanges 28L, 28R, and fasteners 30L, 30R. The tie down anchor body 24, the retainer 26, and the pair of locating flanges 28L, 28R are made of steel or other suitable high strength material and formed by laser cutting a steel metal sheet.

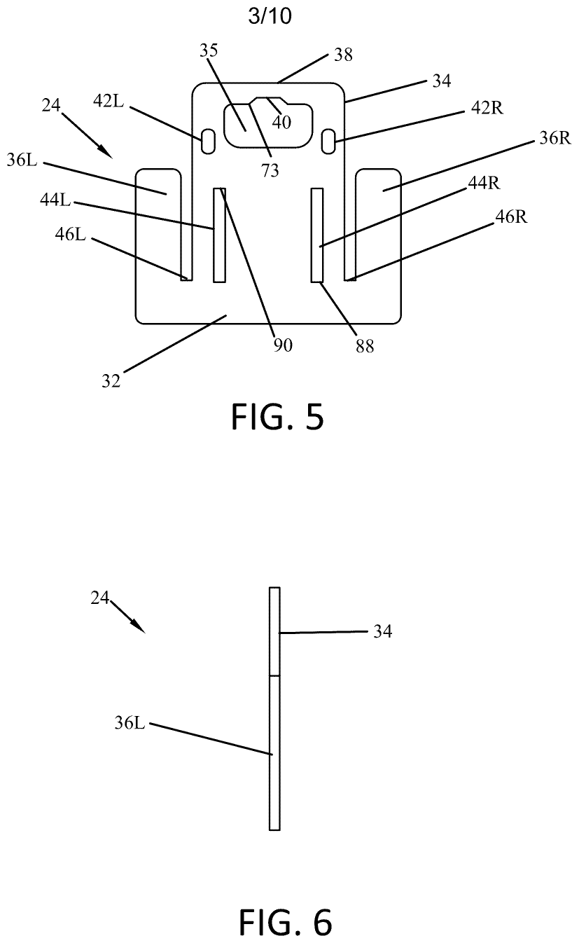

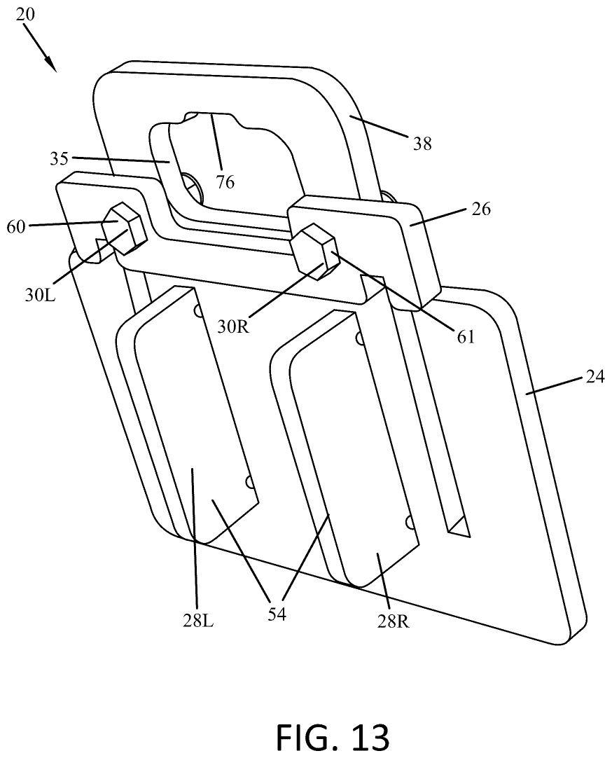

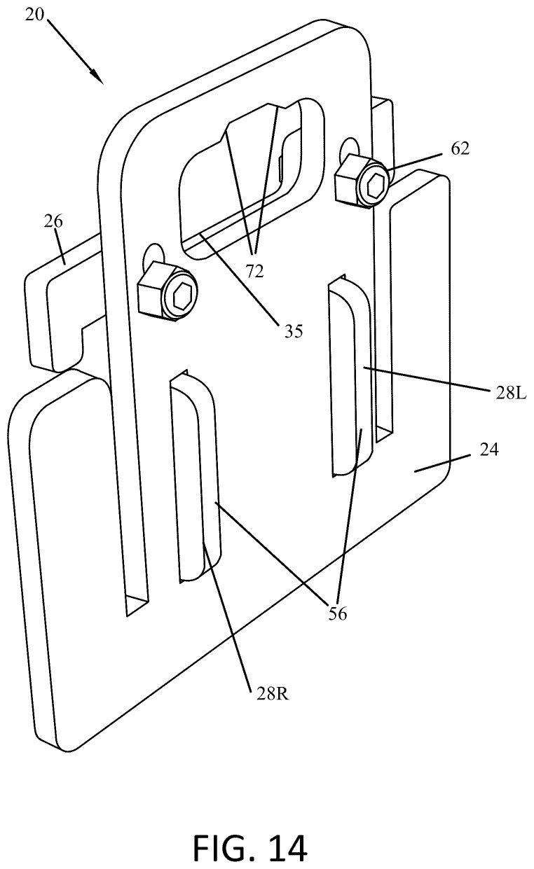

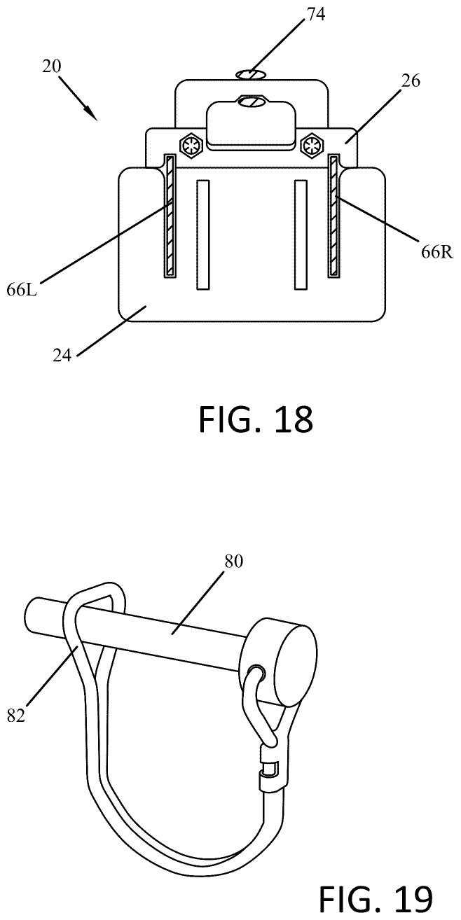

As illustrated in FIGS. 5 and 6, the tie down anchor body 24 is generally flat and relatively thin. The tie down anchor body 24 includes a base 32, a tongue 34, and a pair of right and left arms 36R, 36L. All of these elements of the tie down anchor body 24 are integrally formed in one piece. The base 32 is generally rectangular and is located at the lower end of the tie down anchor body 24. The tongue 34 has a load receiving opening 35 located near the free end or tip 38 of the tongue 34, which along with the tip 38 of the tongue 34 serves as an attachment point. The load receiving opening 35 receives load securing straps 74 (FIG. 18) such as ratchet straps, load securing chains, bungee cords or other load securing flexible members. The load receiving opening 35 is generally rectangular shaped but with the corners rounded to resemble a racetrack. The upper end 73 of the load receiving opening 35 has a central retaining notch 40. The notch 40 has an upper end 76 (FIG. 13) and opposite right and left side ends 72 (FIG. 14) that extend downwardly and outwardly away from each other. The notch 40 receives a complimentary sized load hook (or alternatively securing strap or other load securing flexible member) to minimize right and left lateral movement of the load hook during the towing of the load by the vehicle. A pair of right and left anchor body mounting apertures 42R, 42L are formed in the tongue near respective right and left ends of the tongue. A pair of right and left vertical slits 44R, 44L are formed in the tongue and located below the anchor body mounting apertures 42R, 42L. The tongue 34 is integrally formed with the base 32 at the lower end of the tongue and freely extends upwardly from the base 32.

Each of the arms 36R, 36L are generally rectangular in shape but with rounded corners. The arms 36R, 36L are integrally formed with the base 32 at the lower ends of the arms 36R, 36L. The arms 36R, 36L freely extend upwardly from the base 32. The tongue 34 is located between the right and left arms 36R, 36L and extends upwardly from the base 32 a further distance than the right and left arms 36R, 36L. The tongue 34 is separated from the left arm 36L by a vertical left anchor body groove 46L, and the tongue 34 is separated from the right arm 36R by a vertical right anchor body groove 46R.

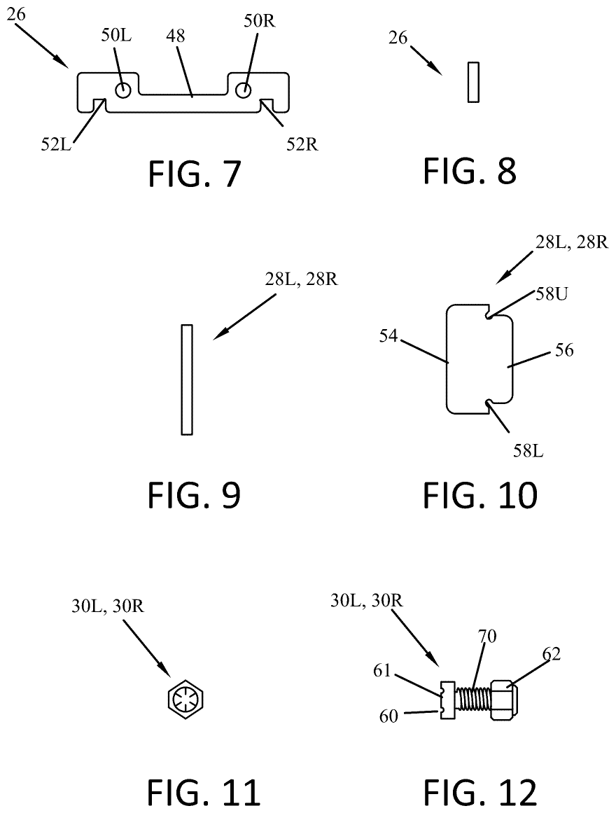

Referring to FIGS. 7 and 8, the retainer 26 is generally elongated from right to left. The retainer 26 includes a U-shaped upper retainer groove 48 formed at its upper end that has a similar width (right to left side) as the width of the load receiving opening 35. The retainer 26 also includes a pair of right and left retainer mounting apertures 50R, 50L. The upper retainer groove 48 is located between the retainer mounting apertures 50R, 50L. A pair of right and left inverted u-shaped lower retainer grooves 52R, 52L are formed at the lower end of the retainer 26.

FIGS. 9 and 10 show one of the locating flanges 28L, 28R. Each of the locating flanges 28L, 28R are of similar construction and function, so for the interest of brevity, one will be described. The locating flange includes a locating portion 54 and a retaining portion 56 located opposite each other and formed in one piece with each other. The locating portion 54 is longer than the retaining portion 56 and extends upwardly and downwardly beyond the retaining portion 56. An upper notch 58U is formed at the upper junction of the locating portion 54 and the retaining portion 56, and a lower notch 58L is formed at the lower junction of the locating portion 54 and the retaining portion 56. FIGS. 11 and 12 show the left and right fasteners 30L, 30R. Each fastener comprises a head screw 60 and a lock nut 62. The head screw 60 may be zinc yellow-chromate plated hex head screw, and the lock nut 62 may be a high-strength steel nylon-insert lock nut. FIG. 19 shows an alternative fastener comprising a clevis pin 80 and cotter pin 82 to removably fasten the retainer 26 to the tic down anchor body 24.

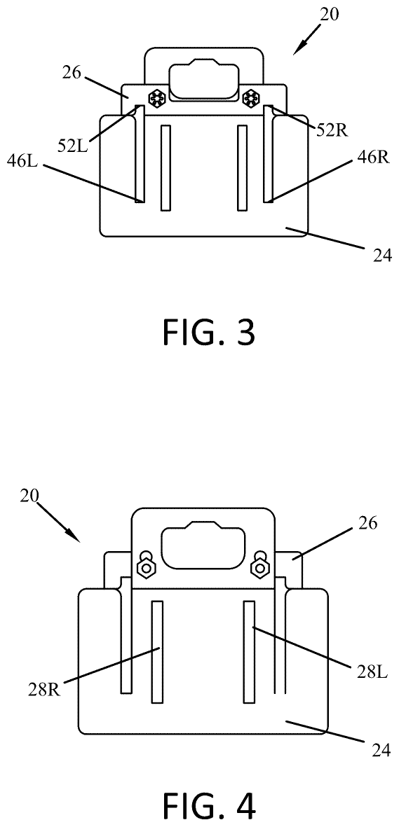

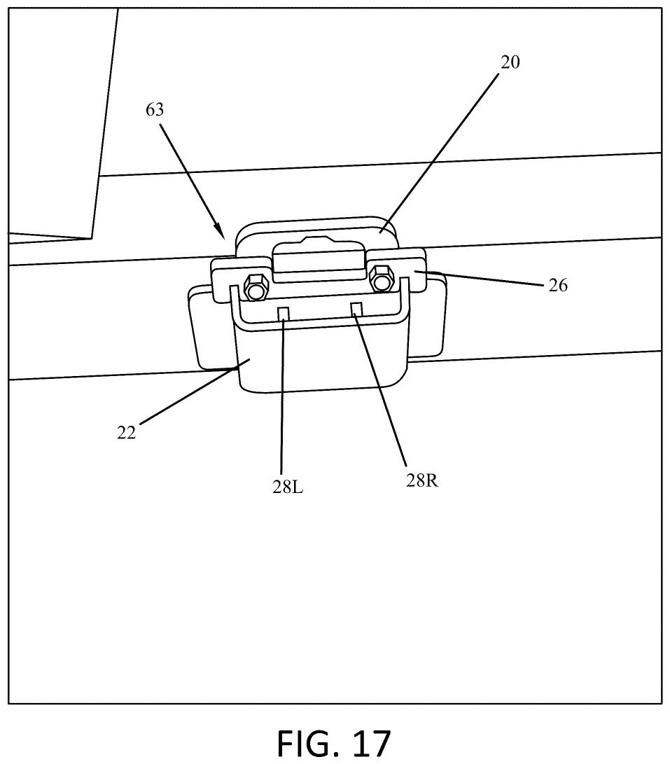

FIGS. 1-4, 13-15, and 17 show all of the elements of the tie down anchor assembly assembled together. Specifically, the locating flanges 28L, 28R are oriented vertically and extend into the right and left slits 44R, 44L such that lower and upper ends 88, 90 (FIG. 5) of the tic down anchor body 24 that define the slits 44L, 44R are received in the respective lower and upper notches 58L, 58U to help secure the locating flanges 28L, 28R to the tie down anchor body 24. The locating flanges 28L, 28R are welded to the tongue 34 to secure the locating flanges 28L, 28R to the tic down anchor assembly 20. The retainer 26 is mounted by the fasteners 30L, 30R to the front of the tic down anchor body 24 at a location above the right and left slits 44R, 44L. In this position, the upper retainer groove 48 is aligned with the load receiving opening 35 such that lower ends of the upper retainer groove 48 and load receiving opening 35 are at the same height. The right and left lower retainer grooves 52R, 52L are aligned over their respective right and left anchor body grooves 46R, 46L as best illustrated in FIG. 3. As seen in FIGS. 1, 13 and 14, a head 61 of the head screw 60 engages the retainer 26 and the lock nut 62 engages the tongue 34 to removably secure the retainer 26 to the tie down anchor body 24.

FIGS. 15, 17 and 18 show an apparatus 63 that has the tie down anchor assembly 20 mounted to the stake bed trailer pocket 22 that has an open ended bottom. As illustrated in FIG. 16, the stake bed trailer pocket 22 is defined by the rear end 64 of the vehicle and right and left side walls 66R, 66L that are interconnected by an outer wall 68. The method to mount the tic down anchor assembly 20 to the stake bed trailer pocket 22 is as follows. First, the locating flanges 28L, 28R are inserted through the slits 44R, 44L such that the locating portion 54 is on one side of the tie down anchor body 24 and the retaining portion 56 is on the opposite side of the tie down anchor body 24. The locating flanges 28L, 28R are then welded to the tic down anchor body 24. Then, the tie down anchor body 24 and locating flanges 28L, 28R are positioned such that the locating flanges 28L, 28R are underneath the pocket opening and the right and left anchor body grooves 46R, 46L are aligned under the right and left side walls 66R, 66L of the stake bed trailer pocket 22. Then, the tie down anchor body 24 is moved upwardly such that the right and left anchor body grooves 46R, 46L slidably receive the right and left side walls 66R, 66L of the stake bed trailer pocket 22.

Then, the retainer 26 is positioned on the tie down anchor body 24 such that the right and left retainer mounting apertures 50R, 50L are aligned with their respective right and left anchor body mounting apertures 42R, 42L, and the right and left lower retainer grooves 52R, 52L are aligned over their respective right and left anchor body grooves 46R, 46L. In this positioned also, the right and left side walls 66R, 66L extend upwardly into the lower right and left retainer grooves 52R, 52L such that the retainer 26 engages the top edge of the right and left side walls 66R, 66L as shown in FIG. 18. Then, the hex head screws 60 are inserted through their respective right and left retainer apertures 50R, 50L of the retainer 26 and right and left anchor body mounting apertures 42R, 42L of the tic down anchor body 24 until the heads 61 of the screws 60 abut the retainer 26. The lock nuts 62 are then threadedly fastened on their respective shanks 70 of the screw 60 and are rotated until they abut the tie down anchor body 24 to clamp the retainer 26 to the tie down anchor body 24. The lower right and left retainer grooves 52R, 52L and the right and left anchor body grooves 46R, 46L surround and engage their respective right and left side walls 66R, 66L of the stake bed trailer pocket 22 to secure the tie down anchor assembly 20 to the stake bed trailer pocket 22 and prevent right and left lateral movement of the tie down anchor assembly 20. The locating flanges 28L, 28R engage the outer wall 68 and rear end 64 to prevent forward and rearward movement of the tie down anchor assembly 20 and help position the tie down anchor assembly 20 within the stake bed trailer pocket 22.

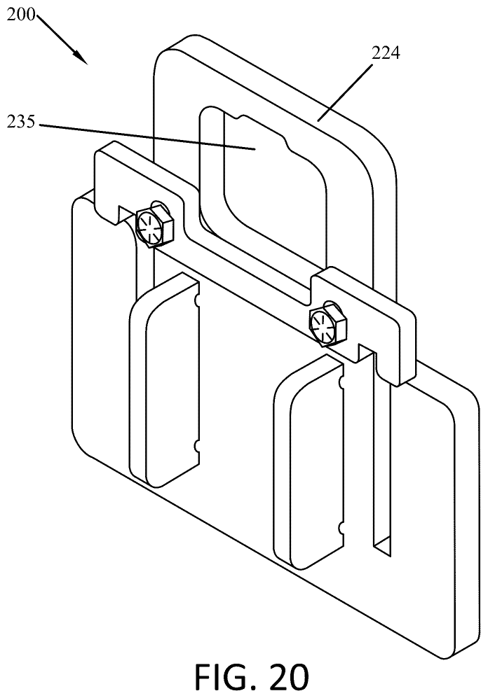

To use the tie down anchor assembly 20, a hook that is attached to a securing strap 74 or other load securing flexible member is hooked around the tip 38 of the tongue 34 to secure the hook to the tie down anchor assembly. Alternatively, if there is no hook, the securing strap 74 may extend through the load receiving opening 35 and over the tip 38 of the tongue 34 to secure the strap 74 to the tie down anchor assembly 20. The tie down anchor assembly 20 utilizes both the mechanical properties of its steel construction and its novel shape to transfer the tension force of the load securing strap 74 (or rope, chain, bungee cord or the like) to the structural frame of a trailer attachment, when towing a load. The tie down anchor wedges into the stake pocket of a stake side bed trailer to provide a robust anchor point for load securing straps such as ratchet straps, load securing chains, bungee cords and other load securing flexible members. The tie down anchor assembly and their elements may have a variety of dimensions. For example, in another embodiment shown in FIG. 20, a tie down anchor assembly 200 is shown having a thicker tie down anchor body 224 and a load receiving opening 235 that has a larger height than that of the tie down anchor body 24 of the tie down anchor assembly 20. All of the other elements of the tie down anchor assembly 200 are similar in construction and function as that of the tie down anchor assembly 20.

Although various embodiments of the disclosed tie down anchor assembly have been shown and described, modifications may occur to those skilled in the art upon reading the specification. The present application includes such modifications and is limited only by the scope of the claims.

What is claimed is:

1. A tie down anchor assembly for a stake pocket, the tie down anchor assembly comprising:
a tie down anchor body, wherein the tie down anchor body includes a load receiving opening, wherein the tie down anchor body includes first and second body grooves;
locating flanges, wherein the locating flanges are attached to the tie down anchor body and are configured to be positioned within the stake pocket; and
a retainer, wherein the retainer is removably mounted to the tie down anchor body and is positioned over the first and second body grooves, wherein the first and second body grooves are configured to receive respective opposite first and second side walls of the stake pocket and the retainer is configured to be positioned over the opposite first and second side walls of the stake pocket to secure the tie down anchor body to the stake pocket.

2. The tie down anchor assembly of claim 1, wherein the retainer is elongated and includes first and second retainer grooves, wherein the first retainer groove is aligned over the first body groove and the second retainer groove is aligned over the second body groove, wherein the first retainer groove is configured to receive the first side wall and the second retainer groove is configured to receive the second side wall.

3. The tie down anchor assembly of claim 1, wherein the locating flanges comprise first and second locating flanges, wherein the tie down anchor body includes first and second slits, wherein the first locating flange includes a first locating portion and a first retaining portion, wherein the first locating portion is larger than the first slit and the first retaining portion is smaller than the first slit, wherein the first locating flange extends through the first slit such that the first locating portion is on one side of the tie down anchor body and the first retaining portion is on the opposite side of the tie down anchor body, wherein the second locating flange includes a second locating portion and a second retaining portion, wherein the second locating portion is larger than the second slit and the second retaining portion is smaller than the second slit, wherein the second locating flange extends through the second slit such that the second locating portion is on one side of the tie down anchor body and the second retaining portion is on the opposite side of the tie down anchor body.

4. The tie down anchor assembly of claim 3, wherein the retainer is elongated and includes first and second retainer grooves, wherein the first retainer groove is aligned over the first body groove and the second retainer groove is aligned over the second body groove, wherein the first retainer groove is configured to receive the first side wall and the second retainer groove is configured to receive the second side wall.

5. The tie down assembly of claim 4, wherein the load receiving opening includes a notch, wherein the notch is configured for receiving a load securing strap to minimize lateral movement of the load securing strap.

6. The tie down assembly of claim 3, wherein the first locating flange comprises a first notch, wherein the first notch is located at a junction of the first locating portion and the first retaining portion, wherein the first notch receives a portion of the tie down body defining the first slit to help secure the first locating flange to the tie down anchor body, wherein the second locating flange comprises a second notch, wherein the second notch is located at a junction of the second locating portion and the second retaining portion, wherein the second notch receives a portion of the tie down body defining the second slit to help secure the second locating flange to the tie down anchor body.

7. The tie down assembly of claim 1, wherein the load receiving opening includes a notch, wherein the notch is configured for receiving a load securing strap to minimize lateral movement of the load securing strap.

8. The tie down assembly of claim 1, further including a fastener, wherein the retainer includes a retainer mounting aperture, wherein the tie down anchor body includes an anchor body mounting aperture aligned with the retainer mounter aperture, wherein the fastener extends through the retainer mounter aperture and the anchor body mounting aperture to removably mount the retainer to the tie down anchor body.

9. An apparatus comprising:
a stake pocket, wherein the stake pocket comprises opposite first and second side walls that are interconnected by an interconnecting wall, wherein the stake pocket is configured to be mounted to a vehicle; and
a tie down anchor assembly, wherein the tie down anchor body is secured to the stake pocket, wherein the tie down anchor assembly comprises:
a tie down anchor body, wherein the tie down anchor body includes a load receiving opening, wherein the tie down anchor body includes first and second body grooves;
locating flanges, wherein the locating flanges are attached to the tie down anchor body and are positioned within the stake pocket; and
a retainer, wherein the retainer is removably mounted to the tie down anchor body and is positioned over the first and second body grooves,
wherein the first body groove receives the first side wall, wherein the second body groove receives the second side wall, wherein the retainer is configured to be positioned over the opposite first and second side walls of the stake pocket to secure the tie down anchor body to the stake pocket.

10. The apparatus of claim 9, wherein the retainer is elongated and includes first and second retainer grooves, wherein the first retainer groove is aligned over the first body groove and second retainer groove is aligned over the second retainer groove, wherein the first retainer groove receives the first side wall and the second retainer groove receives the second side wall.

11. The apparatus of claim 9, wherein the locating flanges comprise first and second locating flanges, wherein the tie down anchor body includes first and second slits, wherein the first locating flange includes a first locating portion and a first retaining portion, wherein the first locating portion is larger than the first slit and the first retaining portion is smaller than the first slit, wherein the first locating flange extends through the first slit such that the first locating portion is on one side of the tie down anchor body and the first retaining portion is on the opposite side of the tie down anchor body, wherein the second locating flange includes a second locating portion and a second retaining portion, wherein the second locating portion is larger than the second slit and the second retaining portion is smaller than the second slit, wherein the second locating flange extends through the second slit such that the second locating portion is on one side of the tie down anchor body and the second retaining portion is on the opposite side of the tie down anchor body.

12. The apparatus of claim 11, wherein the retainer is elongated and includes first and second retainer grooves, wherein the first retainer groove is aligned over the first body groove and second retainer groove is aligned over the second retainer groove, wherein the first retainer groove receives the first side wall and the second retainer groove receives the second side wall.

13. The apparatus of claim 12, wherein the load receiving opening includes a notch, wherein the notch is configured for receiving a load securing strap to minimize lateral movement of the load securing strap.

14. The apparatus of claim 11, wherein the first locating flange comprises a first notch, wherein the first notch is located at a junction of the first locating portion and the first retaining portion, wherein the first notch receives a portion of the tie down body defining the first slit to help secure the first locating flange to the tie down anchor body, wherein the second locating flange comprises a second notch, wherein the second notch is located at a junction of the second locating portion and the second retaining portion, wherein the second notch receives a portion of the tie down body defining the second slit to help secure the second locating flange to the tie down anchor body.

15. The apparatus of claim 9, wherein the load receiving opening includes a notch, wherein the notch is configured for receiving a load securing strap to minimize lateral movement of the load securing strap.

16. The apparatus of claim 9, further including a fastener, wherein the retainer includes a retainer mounting aperture, wherein the tie down anchor body includes an anchor body mounting aperture aligned with the retainer mounter aperture, wherein the fastener extends through the retainer mounter aperture and the anchor body mounting aperture to removably mount the retainer to the tie down anchor body.

17. The apparatus of claim 9, wherein the locating flanges extend from the intermediate wall in the direction along the length of the first and second side walls, wherein the locating flanges are configured to engage the vehicle when the stake pocket is mounted to the vehicle.
